(19) United States
(12) Patent Application Publication
(10) Pub. No.: US 2025/0110007 A1
(43) Pub. Date: Apr. 3, 2025

(54) IDENTIFICATION AND VALIDATION OF GAS LEAK SOURCE

(71) Applicant: Schlumberger Technology Corporation, Sugar Land, TX (US)

(72) Inventors: Kashif Rashid, Wayland, MA (US); Andrew J. Speck, Milton, MA (US)

(21) Appl. No.: 18/898,071

(22) Filed: Sep. 26, 2024

Related U.S. Application Data
(60) Provisional application No. 63/586,541, filed on Sep. 29, 2023.

(51) Int. Cl. G01M 3/04; G06F 18/20

(52) U.S. Cl. CPC G01M 3/04; G06F 18/295

(57) ABSTRACT

Systems and methods are described for identifying and validating a fugitive gas leak. The system identifies the onset of a leak, tracks its persistence, and subsequently, notes its gradual disappearance after repairs are initiated. The method comprises initiating an observation period which serves to characterize the behavior of the anticipated leak if it exists. Extracting the underlying distributions of the parameter space for the anticipated leak over an observation period. Data is collected over incremental steps and compared to the current reference distributions. When the test period is complete, the observation window is moved forward to include the data over the validation span. The procedure thus repeats, with an updated reference distribution and re-initialized validation period.

### CROSS REFERENCE PARAGRAPH

This application claims the benefit of U.S. Provisional Application No. 63/586,541, entitled “IDENTIFICATION AND VALIDATION OF GAS LEAK SOURCE” filed Sep. 29, 2023, the disclosure of which is hereby incorporated herein by reference.

### BACKGROUND

Calculating the emission rate of fugitive gases is an important part of detecting and determining the extent of leaks resulting from mining activity. These fugitive gas emissions contribute to greenhouse gas emissions that are harmful to the environment. Many fugitive emissions are the result of loss of well integrity through poorly sealed well casings due to geochemically unstable cement. This allows gas to escape through the well itself (known as surface casing vent flow) or via lateral migration along adjacent geological formations (known as gas migration).

Gas imagers scan a finite field of view (“FOV”) at a time. Some solutions include scanning pattern continuously and cyclically iterating through these predefined frames, acquiring images, and marking the images as positive if it sees an identifiable plume within the frame or negative if it does not. Each acquisition acts as a standalone observation. In solutions with recentering and zooming capabilities, upon plume detection, the imager may recenter on an estimated plume origin and acquire an additional frame at a predefined zoom (same as or different from the original zoom level). Even with optimally selected frames, such a scan cycle is prone to false positives from noise as well as large plumes spread across multiple frames, restricts attribution to sources within these predetermined frames, increases the likelihood of attributing an emission to an incorrect source, reduces the accuracy with which the duration of a leak can be calculated, limits leak rate quantification accuracy, and is susceptible to false negatives if the imager sees a portion of the plume but does not see an identifiable plume origin.

With rising concerns around gas emissions (especially greenhouses gases such as methane and carbon dioxide), it is crucial to accurately detect gas emissions along with their source, duration, and emission rate. As a result, a need exists for a gas imaging system that can adapt to real-time detections and changes.

### SUMMARY

Examples described herein include methods for continuous leak estimation and validation of a fugitive gas leak source. The method can be applied over a stipulated observation period, in order to quantify the leak source.

In one example, the method identifies and traces the existence of a leak based on a moving observation window and a validation period that may be incrementally constructed in smaller steps. The existence of a leak is derived by comparing the data gathered during the validation phase with the reference distribution established from the observation period. A non-zero measure of the area under the overlapping curve serves as an indication of leak existence, and a tighter estimate can be obtained by extracting the overlapping region of the data from multiple days stipulated in the observation period.

In another example, the method also includes a coverage measure that enables identification of true positive and true negative leaks, or indeed, if the prevailing wind data is insufficient in time or spatial resolution. Collectively, the method serves to identify the origination of a leak, track its persistence and ultimately, its disappearance subsequent to leak repairs. Post-ante analysis using all the available data over the identified leak period permits quantification of total emissions.

an automatic and adaptive scanning method to efficiently scan for gas plumes originating from a facility using an imaging or LiDAR based gas monitoring system. In an example, a gas monitoring system can be coupled to a laser absorption spectroscopy with LiDAR. The gas monitoring system can have the ability to connect to an anemometer, change zoom level, and control the heading and tilt of a gas imaging camera (referred to interchangeably with “imager” and “camera”).

In an example, a computing device in the gas monitoring system receives a gas density image of a fugitive gas from a gas imaging camera. The computing device determines how to optimize the fugitive gas in the camera's field of view (“FOV”) and instructs the camera to dynamically adjust its bearing and zoom accordingly. In one example, if the fugitive gas is present in less than a threshold percentage of the image, then the computing device can send instructions to the camera to adjust its zoom and bearing (e.g., pan and tilt), to center the fugitive gas and increase its presence in the camera's FOV. If the gas plume is too large, then the computing device can instruct the camera to zoom out and adjust its bearing to decrease the gas plume's presence. In one example, the computing device can continue to adjust the camera until the camera captures an image of the fugitive gas that satisfies preset parameters. In an example where a single image cannot capture the gas plume based on the parameters (i.e., the gas plume extends horizontally beyond the FOV of the camera), then the computing device can instruct the camera to capture multiple images of the gas plume and then stitch the images together.

In another example, when a gas emission is detected in an image, the computing device can determine the location with the highest gas concentration in the image. If the highest concentration point is close to the center of the field of view (e.g., within 15% of the central area of the frame), the frame is assumed to contain the true leak source. The computing device marks the image frame as positive for gas emission, and the gas monitoring system can continue to scan the nearby area for gas emissions. If the highest concentration is not within a threshold area of the central area of the image, then the gas monitoring system can adjust the imager to capture a second image that is centered around the point with the highest concentration in the first image. This recentering process continues until the highest concentration point is within an expected area around the center of the image.

When the appropriate final image(s) has been obtained, the computing device can calculate the emission rate. The final image could be the second image, third image or nth image. In one example, the computing device can delineate the fugitive gas in the image and determine the gas's volume by converting pixels to units of length. This conversion can be done, for example, using the camera's angle and a measured length from the camera to the gas. The volume, along with other relevant data like wind measurements, can be inputted into an equation that outputs a flux measurement. In another example, the computing device can calculate the emission rate by dividing the plume into multiple cross-sectional planes, calculating the flux for each plane, and then averaging the fluxes together.

Both the foregoing general description and the following detailed description are exemplary and explanatory only and are not restrictive of the examples, as claimed.

### BRIEF DESCRIPTION OF THE DRAWINGS

FIG. 1 is an illustration of example result of leak inversion method.

FIG. 2A-2D are illustrations of Monte-Carlo Markov Chain results.

FIG. 3 is an illustration of overlapping region between two distributions.

FIG. 4 is an example of an incremental schema.

FIG. 5 is an example of the procedure over four validation days.

FIG. 6A-6J are examples of a validation scheme.

FIG. 7 is an example of a validation scheme.

FIG. 8 is an illustration of an example method for detecting and validating methane leaks.

FIG. 9 is an illustration of an example system for detecting and validating methane leaks.

### DETAILED DESCRIPTION

Reference will now be made in detail to the present examples, including examples illustrated in the accompanying drawings. Wherever possible, the same reference numbers will be used throughout the drawings to refer to the same or like parts.

Systems and methods are described for identifying and quantifying a fugitive gas leak source.

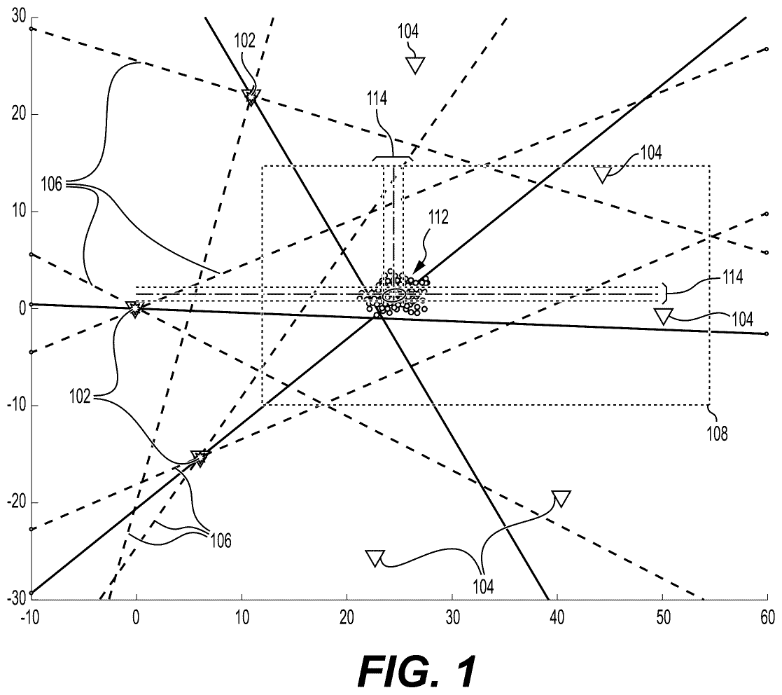

The methane leak inversion procedure described herein can be applied over a stipulated observation period, denoted T, in order to quantify a leak source. FIG. 1 illustrates an example of leak source detection results based on a layout incorporating eight sensors, identified as sensors 102 and 104, with 51 records generated over a specified period. Three of these sensors, identified as 102, are active and produce linear cuts, represented by dashed lines 106, which define the reduced bounds indicated by frame 108. The outcome of a Monte-Carlo Markov Chain (“MCMC”) uncertainty quantification procedure is depicted by the shaded region 110, shown in two dimensions alongside 95% confidence intervals 114.

The MCMC procedure includes spatial parameters for the three-dimensional physical space that encompasses the methane leak, including an x coordinate denoted Sx, a y coordinate denoted Sy, and a z coordinate denoted Sz. The MCMC procedure can also include a rate or magnitude parameter, denoted by Sr. Sr represents probable values for a rate or magnitude of methane based on the MCMC samples.

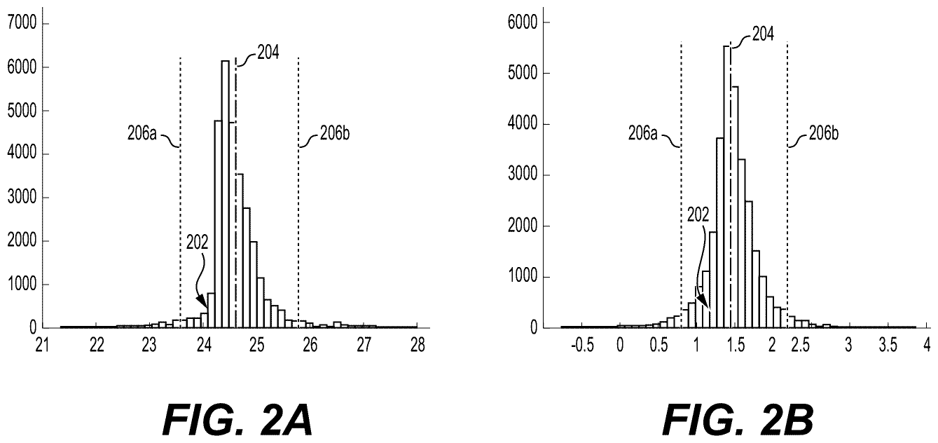

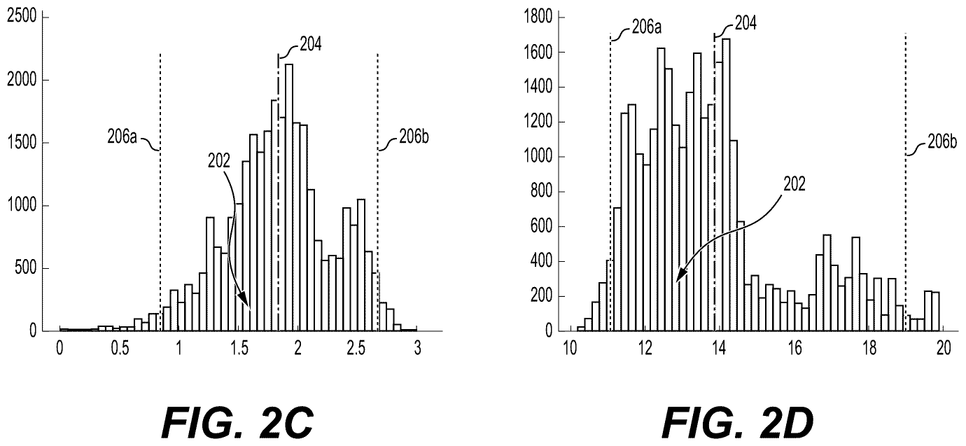

The distributions for each of the parameters of the MCMC procedure are shown in FIGS. 2A-2D, where FIG. 2A shows the Sx distribution, FIG. 2B shows the Sy distribution, FIG. 2C shows the Sy distribution, and FIG. 2D shows the Sr distribution. The magnitudes of each parameter are illustrated by columns 202. FIGS. 2A-2D also show the median value 204 as well as the lower 206a and upper 206b ends of the 95% confidence interval limits, thereby indicating the likely source of the leak based on the available data.

The definitive distribution of the anticipated leak can be established over an observation period T, assuming that the duration is sufficiently long to quantify the leak. Data collected during a subsequent validation period t can then be compared to the reference distribution to determine if the same leak can be inferred. An incremental period dt may be employed to continuously collect and process data as it is acquired. Once the period t is reached, the observation window may be updated accordingly. Ideally, the distributions gathered over dt and t would be compared with the reference distribution gathered over T. However, validation of distributions over t and dt is challenging, as these periods are smaller in comparison to T and the data volume will differ. Additionally, weather conditions may not be favorable for generating a sufficient number of meaningful records, and different constraint sets may arise, resulting in different linear cuts generated from the available data over the given time period. Consequently, variations in distributions are likely, and a direct measure of similarity based on Probability Density Function (“PDF”), Cumulative Distribution Function (“CDF”), boxplots, or Kolmogorov-Smirnov tests may not be sufficient.

An alternative approach involves testing whether the data collected during the validation period indicates the observed leak by noting a significant overlap with the reference distribution. A greater overlap strengthens the evidence that a leak identified in the validation period is the same as that observed during the observation period. This concept of overlapping distributions applies to multiple distributions gathered over multiple days, and if overlap exists, it provides a more robust estimate of the parameters, which can be advantageous in constructing a more stringent test for leak validation.

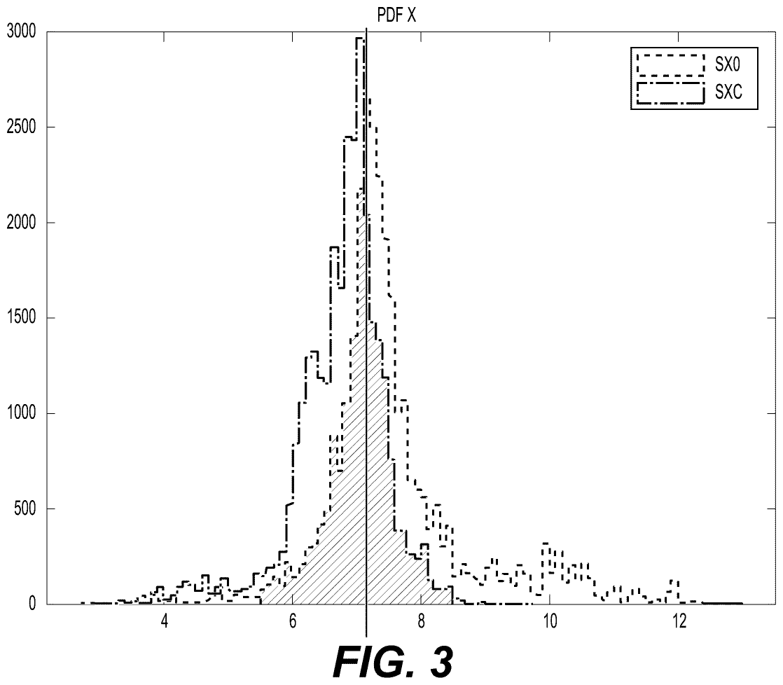

An example illustration of the overlap described above is shown in FIG. 3. The Sx reference distribution (over T) (illustrated as line 302) and the validation distribution (over t) (illustrated as line 304) are both shown. The overlapping region 306 shows where the reference distribution 302 and validation distribution 304 overlap. A significant overlap provides a strong indication of leak presence, and this may be noted as corroborating evidence. On the other hand, little or no overlap provides weak indication of leak presence, and this may be noted as a lack of corroborating evidence.

With this notion of overlapping distributions as a validation measure, the following can be asserted. Let the observation period T be long enough to capture the core distribution (e.g., 3 days). Let the validation period t be long enough to capture continued activity with sufficient wind variation (e.g., 24 hours). Let the incremental period dt be long enough to provide records and an estimation of a leak from the data gathered over the smaller step. If the period is too small, no records will be generated (e.g., 3 hours).

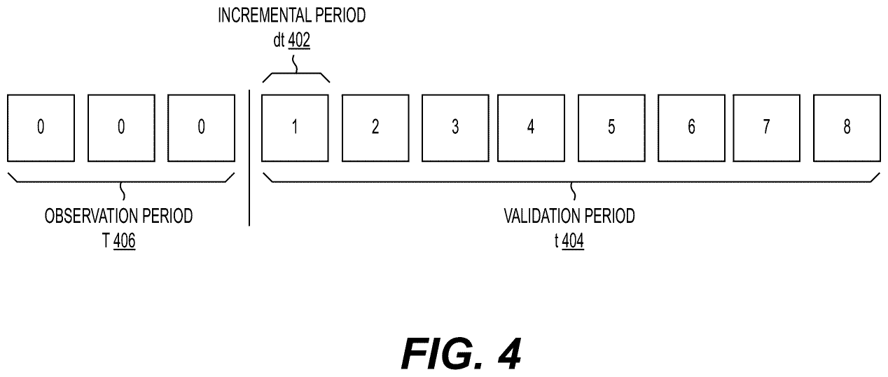

The validation procedure can be demonstrated by taking incremental steps over a smaller period dt as shown in FIG. 4. FIG. 4 includes an observation period T 406 and a validation period 404. Each block 402 of size dt is processed in a cumulative manner by step until the full validation period t 404 is reached. Once the full period is evaluated, the moving window is updated to include the new period t.

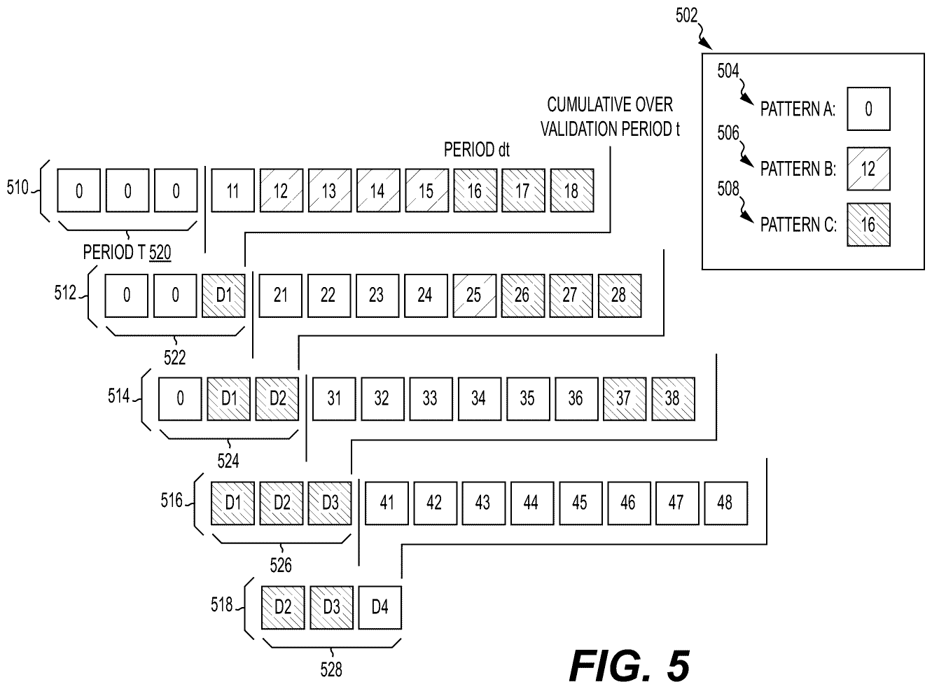

The incremental processing workflow is shown by the example schema in FIG. 5 with the daily time iteration appearing by row. The key 520 shows patterns A 504, B 506, and C 508. Blocks with pattern A 504 represent time blocks where there is no leak information. Blocks with pattern B 506 indicates some data, but insufficient to perform inversion. The term “inversion” refers to a computational technique used to estimate the source, location, and quantity of methane emissions based on observed data. Pattern C 508 indicates sufficient data to perform inversion.

In the first row 510, the blocks of the observation window 520 are all of pattern A 504, indicating that there is no leak information. Each of rows 510, 512, 514, 516, and 518 represent a different day in descending order. Incremental processing yields one pattern A block, 4 pattern B blocks and 3 pattern C blocks. Subsequently, the observation window 522 moves forward to contain leak information from day 1 (D1). Incremental processing now yields 4 pattern A blocks (no information for 12 hours), one pattern B block, and 3 pattern C blocks. The observation window 524 moves forward to contain leak information from days 1 and 2.

Incremental processing over day three gives 6 pattern A blocks (no information for 18 hours) and 2 pattern B blocks. The observation window 526 moves forward and contains information from all three days. In all subsequent processing, there is no leak information, so the observation window will move onwards, until the existing leak information disappears. The continuous incremental monitoring and evaluation procedure thus allows the identification of the leak's start, persistence, and disappearance. Post-ante evaluation also permits the given leak life-cycle to be fully quantified.

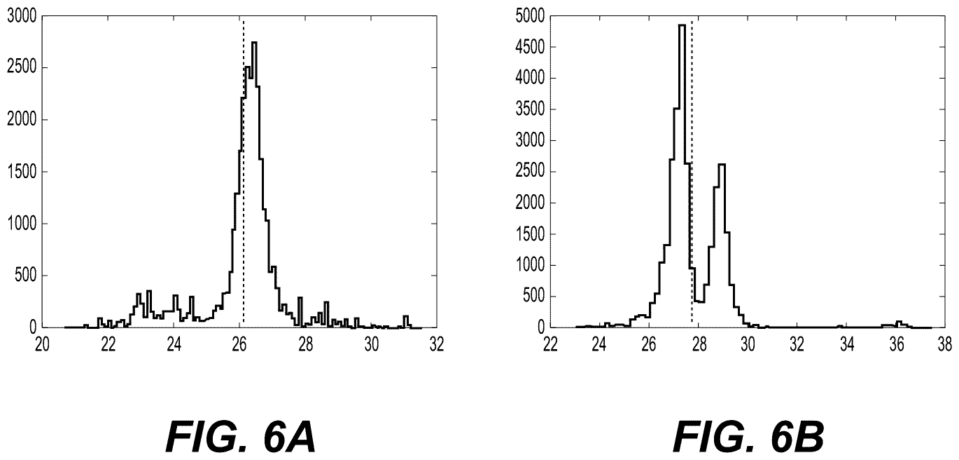

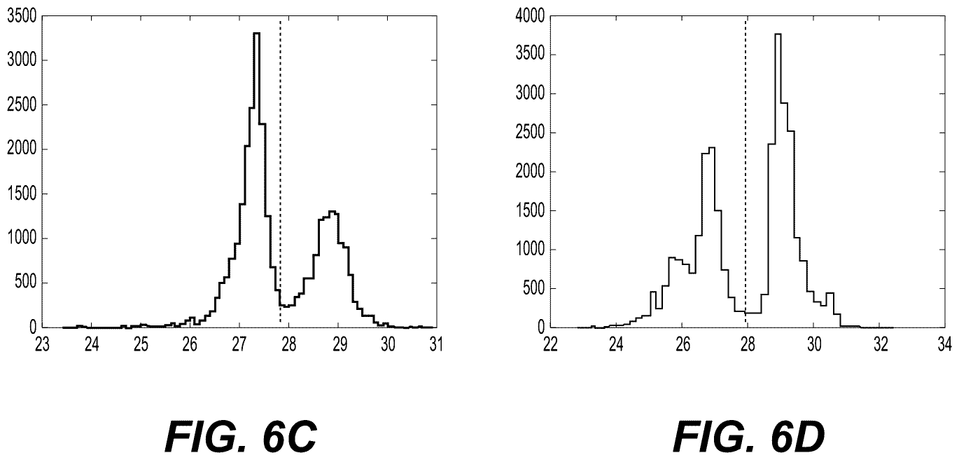

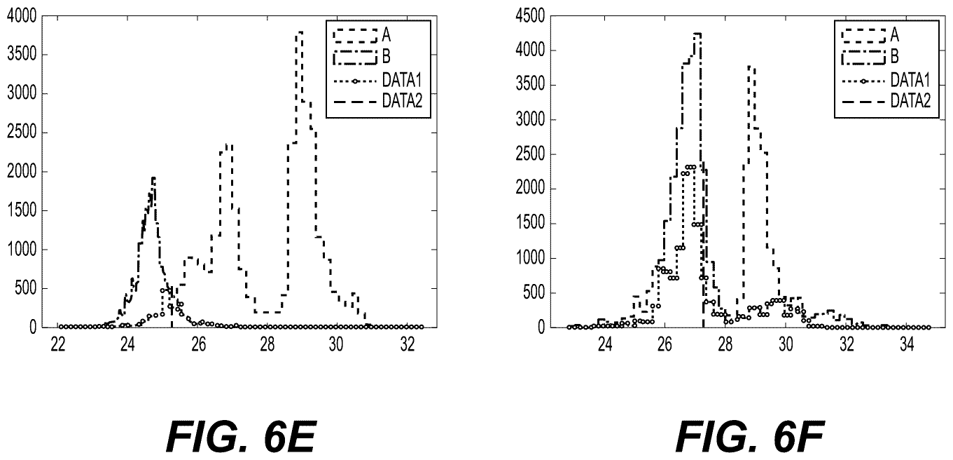

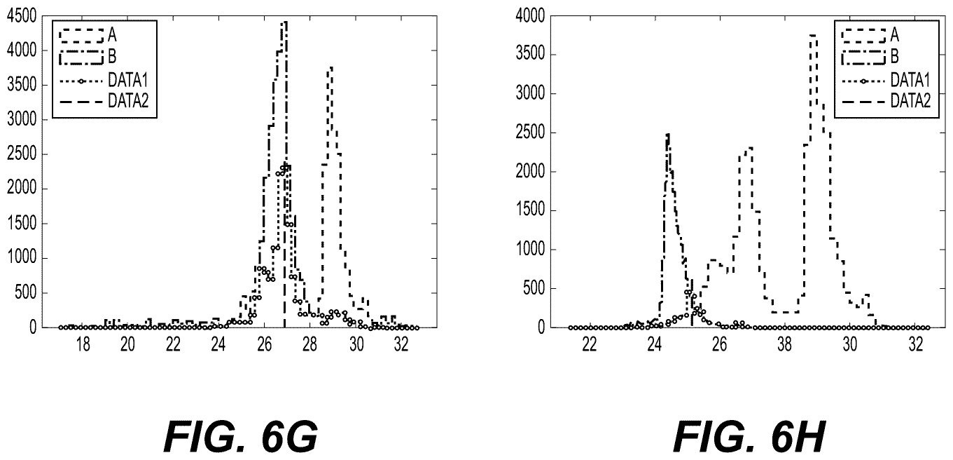

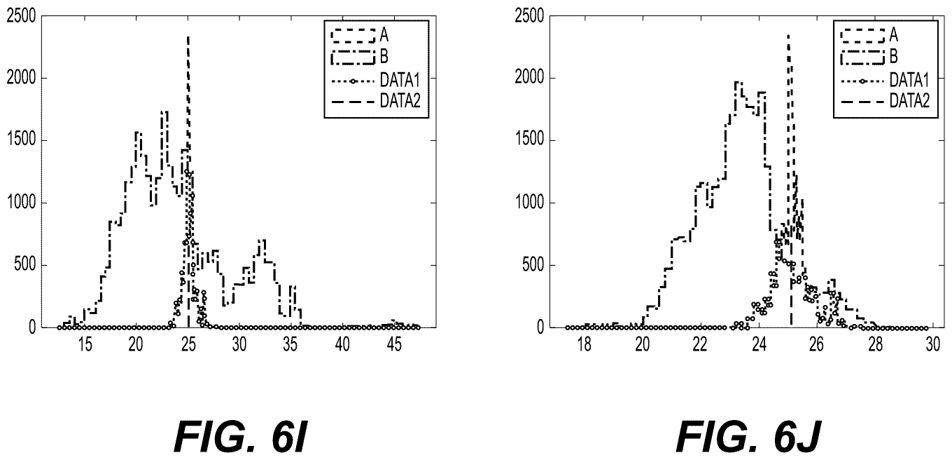

In the described methodology, the extraction and analysis of overlapping distributions are employed to detect and validate methane leaks over a series of observational periods. The process begins with the establishment of an initial reference distribution, denoted as D0, which represents a baseline scenario with no detected leak, characterized by a flatline distribution. This reference serves as the starting point for subsequent analysis. FIGS. 6A-6J are graphs of example methane readings along the Sx parameter and illustrate the incremental processing of distributions.

During the monitoring process, distributions for the Sx parameter are analyzed over specific time periods. For example, FIG. 6A shows the methane distribution on the Sx parameter at time T16 of day 1, FIG. 6B shows the methane distribution on the Sx parameter at time T17 of day 1, and FIG. 6C shows the methane distribution on the Sx parameter at time T18 of day 1. Following the evaluation of data from day 1, the reference distribution is calculated, as shown in FIG. 6D. This updated distribution forms the basis for analyzing the overlapping distributions observed during periods T26, T17, T28 on day 2, where are illustrated in FIG. 6E, 6F, and 6G, respectively.

The overlap between the reference distributions from days 1 and 2 results in a new distribution, denoted as D012, which is illustrated in FIG. 6H. This robust distribution D012 is preferred over the cumulative distribution D12, as it offers a more stringent criterion for leak validation.

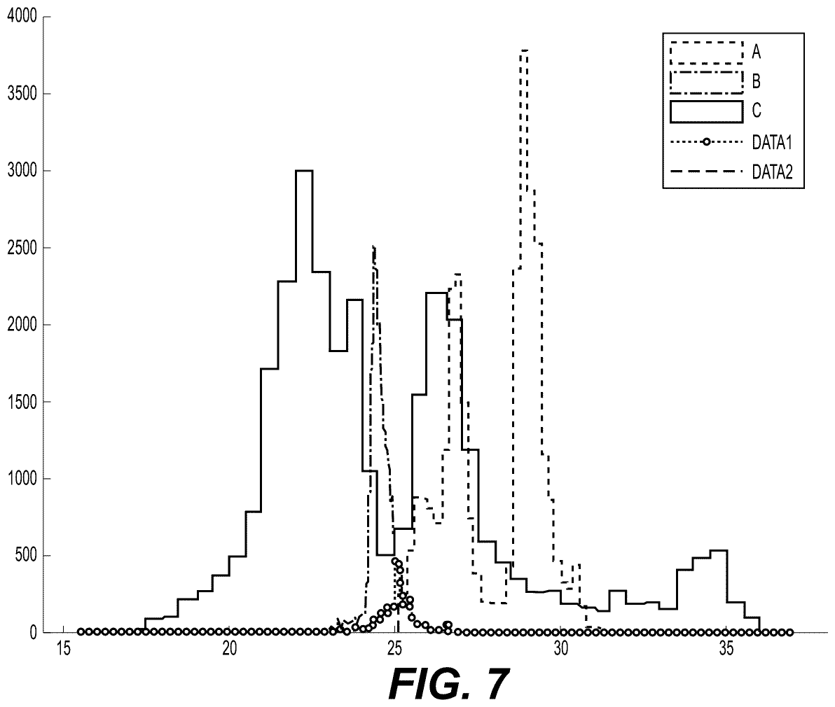

Continuing this methodology, FIGS. 6I and 6J illustrate the overlap of the reference distribution D012 with the distributions observed during periods T37 and T38 on day 3, respectively. The reference distribution is further refined in FIG. 7, representing the overlap of data from days 1-3. Notably, as no leak information is detected on days 4 and 5, the analysis reveals zero overlap, and the reference distribution, denoted D456, reverts to a flatline, indicating the absence of leaks. This progression of analysis is systematically conducted, with the moving window adjusting to incorporate new data, until the reference distribution registers no additional leak information.

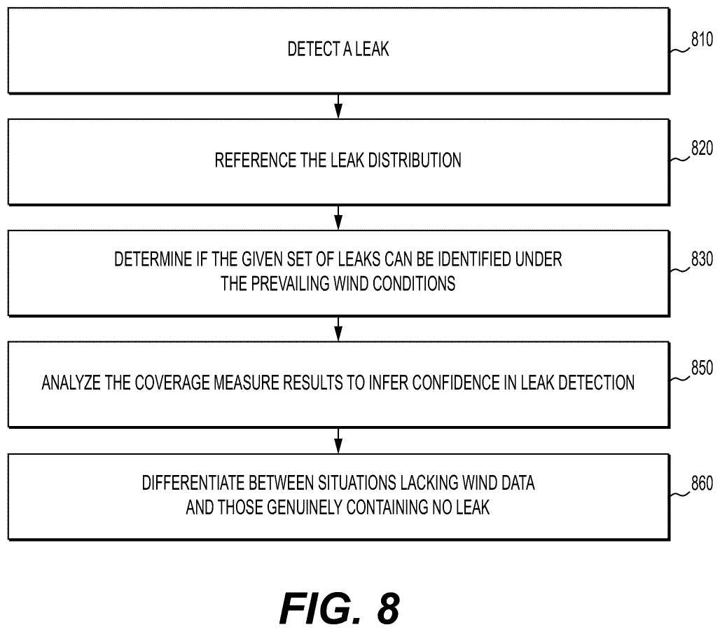

The incremental results indicate the presence or absence of a leak. The positive result indicates the existence of a leak, but the null event does not preclude that possibility. That is, over a limited time period, the prevailing wind conditions may not have been sufficient to isolate the leak. Hence, additional information can be obtained in order to resolve a potentially false negative result. FIG. 8 is an example method for detecting and validating methane leaks.

At stage 810, a leak can be detected. For example, atmospheric data, including methane concentrations and relevant environmental parameters such as wind speed and direction, can be collected over a designated geographic area using sensors that may be ground-based, airborne, or satellite-mounted. A reference distribution, denoted as D0, is established to represent a baseline scenario with no methane leak present, characterized by a flatline distribution indicating stable methane concentrations without significant anomalies. The collected data is then segmented into specific time periods and analyzed for key parameters, including spatial coordinates (X, Y, Z) and additional relevant factors (R), generating distribution plots for each parameter within the designated periods.

These generated distributions can be subsequently compared against the baseline reference distribution D0, with the aim of identifying any overlaps or deviations that may suggest the presence of a methane leak. A non-zero overlap or significant deviation from the reference distribution D0 is recognized as a potential indication of a methane leak, providing preliminary insights into the leak's location, intensity, and possible source.

Stage 820 includes referencing the leak distribution. For example, a reference leak distribution can be generated using samples from the MCMC procedure. These samples represent the expected parameter distributions under normal conditions, with no leak present, and are used to create a reference distribution denoted as D1. This distribution provides a detailed representation of the parameter space and serves as a benchmark for detecting deviations that may indicate the presence of a methane leak.

Randomly generated samples are then selected from the MCMC points or from the individual distributions identified. These samples are tested as potential leaks to evaluate their impact on the reference distribution. By comparing the observed data with the reference distribution D1, the method assesses how well these samples align with the expected parameter distributions. This comparison is crucial for identifying any anomalies or deviations that might suggest a leak.

Referencing leak distribution helps to refine the detection process by providing a robust baseline for comparison. It ensures that the identified leaks are compared against a well-defined standard, enhancing the accuracy and reliability of the leak detection and validation. This step lays the groundwork for subsequent analysis and helps in distinguishing between true leak signals and background noise.

Stage 830 includes determining if the given set of leaks can be identified under the prevailing wind conditions. A coverage map can be generated, which represents the area of interest and reflects the distribution of methane concentrations and wind patterns over time. The coverage map is used to assess the extent to which the detected leak overlaps with areas where the wind conditions are favorable for detection.

To perform the coverage evaluation, a set of samples can be drawn from the reference distribution established in the first step. These samples may represent potential leak locations or characteristics and are tested against the prevailing wind conditions to determine if they can be effectively identified. The coverage metric, calculated as the percentage of samples that can be accurately detected, serves as a critical measure of the detection process's robustness.

This step can be conducted iteratively, with the coverage metric being updated as more wind data becomes available. Each iteration involves drawing new samples from the updated reference distribution and recalculating the coverage metric. As the process continues, the coverage measure typically improves, providing increasing confidence in the leak detection. If the coverage metric remains low despite multiple iterations, it may indicate the need for additional wind data or longer observation periods to ensure accurate leak identification. This step ensures that the initial detection is validated and helps differentiate between true leaks and those that may have been missed due to inadequate environmental conditions.

Stage 840 includes analyzing the coverage results to infer confidence in leak detection. A high coverage metric, such as above 80%, can indicate strong confidence that the detected leak is accurate and has been effectively identified under the given environmental conditions. This high coverage suggests that the sampling and wind data were sufficient to capture the leak accurately, supporting the reliability of the detection process.

Conversely, a low coverage metric, such as below 20%, can signal that the wind conditions or data availability were insufficient for accurate leak identification. In such cases, the low coverage could indicate either a genuine lack of detectable leaks or a need for additional wind data and longer observation periods to improve detection accuracy. Low coverage results require careful consideration, as they may highlight gaps in the data or limitations in the detection process.

The interpretation of coverage results also involves comparing these metrics with the leak estimates to classify them into categories such as True Positive, True Negative, or cases requiring further investigation. A True Positive is a confirmed leak with high coverage, while a True Negative represents accurate identification of no leak with high coverage. Low coverage in a positive leak scenario might indicate a new or emerging leak not yet fully captured by the existing data. This detailed interpretation helps differentiate between cases where additional data is needed and those where no leak is present, guiding subsequent actions and improvements in the detection process.

Stage 850 includes differentiating between lack of data and genuine absence of leak. The coverage information provides insights into whether the detected low coverage metrics result from inadequate wind data or from the actual absence of a leak. When coverage metrics are low, it may be indicative of insufficient environmental data or limitations in detection capability due to variable wind conditions. By analyzing coverage results in conjunction with the leak estimates, it is possible to assess whether the low coverage reflects a genuine lack of detectable leaks or simply inadequate data for accurate detection.

Conversely, if the coverage metric is high and still no leaks are detected, it strongly suggests that the area being monitored is free of methane leaks. This outcome confirms that the detection process, supported by sufficient wind data, has accurately assessed the absence of leaks. The detailed interpretation of coverage results ensures that resources are effectively allocated, focusing efforts on areas where data gaps need to be addressed or on confirming areas with detected leaks.

Ultimately, this step enhances the accuracy of the methane leak detection system by enabling precise differentiation between true negatives (no leaks) and cases requiring additional data. It ensures that the detection process is not only reliable but also responsive to varying environmental conditions, leading to more effective leak management and mitigation strategies.

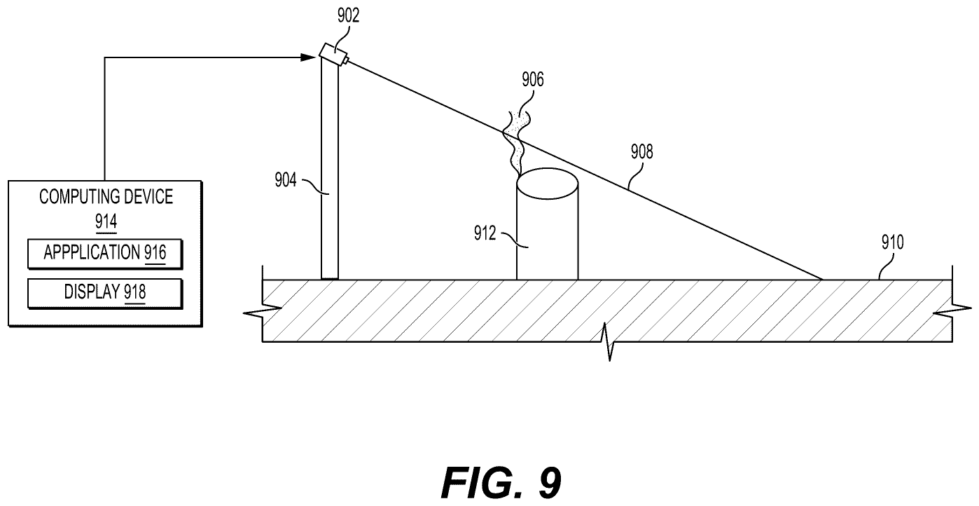

FIG. 9 is an illustration of an example system for detecting and validating methane leaks. The system includes a camera 902, mounted on a tall mast 904. The camera 902 is aimed downward as it detects a methane leak 906 so that the laser beam 908 hits the ground 910 and some light can be scattered back to the camera. The camera 902 can be a LiDAR camera or any other imaging device that can detect methane. The orientation of the camera 902 can be controlled by a pan-tilt stage. The range of pan angles may be up to a full 360 degrees. The range of tilt angles may extend to a maximum of 90 degrees (directly downward) and to a minimum of −90 degrees (directly upward) with the horizon at zero degrees. Because the quantification of methane density requires a return path for scattered radiation, the camera 902 can be mounted on a tall mast 904 so that the infrared laser 908 it emits is scattered by the ground 910 or other surfaces as it scans the equipment 912 at a facility, as illustrated in FIG. 1. The most frequently used range of tilt angles for emissions monitoring is between zero and 90 degrees.

The camera 902 captures real-time imaging data, including measurements of methane concentration, LiDAR range, scattered light intensity, and RGB images, and transmits this data to a connected computing device 914. This data transmission can be facilitated through a secure, high-bandwidth communication link that ensures the integrity and speed of data transfer. Once the data is received by the computing device 914, an application 916 running on the device 914 processes the imaging data to perform the necessary steps for methane leak detection and attribution. The computing device 914 also includes a display 918 that allows the processed data and analysis results, such as the identified leak sources and their confidence levels, to be visually presented to operators. This display 918 enables real-time monitoring and decision-making, ensuring that the detected methane emissions can be promptly addressed.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

What is claimed is:

1. A method for detecting and validating methane leaks comprising:
collecting data from a set of sensors over an observation period, wherein the data includes methane concentration measurements and environmental parameters;
generating, using the collected data and for each of a plurality of spatial parameters, a curve of a distribution of a methane levels;
overlaying the curve for each of the plurality of spatial parameters;
identifying an overlap region in the overlayed curves; and
based on the overlap region, estimating a probable source of a methane leak.

2. The method of claim 1, wherein the curve for each of the plurality of spatial parameters is generated by applying a Monte-Carlo Markov Chain (“MCMC”) procedure to the collected data.

3. The method of claim 1, further comprising:
for each curve, establishing a reference distribution representing a baseline scenario with no detected leak; and
updating the reference distribution based on data collected during subsequent validation periods and incremental periods.

4. The method of claim 1, wherein the overlap region is identified by comparing the generated distributions with a baseline reference distribution using statistical analysis.

5. The method of claim 1, further comprising calculating a coverage metric representing the percentage of samples accurately detected as methane leaks under prevailing environmental conditions.

6. The method of claim 5, wherein the coverage metric is used to determine a confidence level in a plurality of possible leak sources, and the probable source of the methane leak is the possible leak source with the highest confidence level.

7. The method of claim 1, wherein the environmental parameters include at least wind speed and wind direction.

8. A non-transitory, computer-readable medium containing instructions that, when executed by a hardware-based processor, causes the processor to perform stages for detecting and validating methane leaks, comprising:
collecting data from a set of sensors over an observation period, wherein the data includes methane concentration measurements and environmental parameters;
generating, using the collected data and for each of a plurality of spatial parameters, a curve of a distribution of a methane levels;
overlaying the curve for each of the plurality of spatial parameters;
identifying an overlap region in the overlayed curves; and
based on the overlap region, estimating a probable source of a methane leak.

9. The non-transitory, computer-readable medium of claim 8, wherein the curve for each of the plurality of spatial parameters is generated by applying a Monte-Carlo Markov Chain (“MCMC”) procedure to the collected data.

10. The non-transitory, computer-readable medium of claim 8, the stages further comprising:
for each curve, establishing a reference distribution representing a baseline scenario with no detected leak; and
updating the reference distribution based on data collected during subsequent validation periods and incremental periods.

11. The non-transitory, computer-readable medium of claim 8, wherein the overlap region is identified by comparing the generated distributions with a baseline reference distribution using statistical analysis.

12. The non-transitory, computer-readable medium of claim 8, the stages further comprising calculating a coverage metric representing the percentage of samples accurately detected as methane leaks under prevailing environmental conditions.

13. The non-transitory, computer-readable medium of claim 12, wherein the coverage metric is used to determine a confidence level in a plurality of possible leak sources, and the probable source of the methane leak is the possible leak source with the highest confidence level.

14. The non-transitory, computer-readable medium of claim 8, wherein the environmental parameters include at least wind speed and wind direction.

15. A system for detecting and validating methane leaks, comprising:
a memory storage including a non-transitory, computer-readable medium comprising instructions; and
at least one hardware-based processor that executes the instructions to carry out stages comprising:
collecting data from a set of sensors over an observation period, wherein the data includes methane concentration measurements and environmental parameters;
generating, using the collected data and for each of a plurality of spatial parameters, a curve of a distribution of a methane levels;
overlaying the curve for each of the plurality of spatial parameters;
identifying an overlap region in the overlayed curves; and
based on the overlap region, estimating a probable source of a methane leak.

16. The system of claim 1, wherein the curve for each of the plurality of spatial parameters is generated by applying a Monte-Carlo Markov Chain (“MCMC”) procedure to the collected data.

17. The system of claim 1, the stages further comprising:
for each curve, establishing a reference distribution representing a baseline scenario with no detected leak; and
updating the reference distribution based on data collected during subsequent validation periods and incremental periods.

18. The system of claim 1, wherein the overlap region is identified by comparing the generated distributions with a baseline reference distribution using statistical analysis.

19. The system of claim 1, the stages further comprising calculating a coverage metric representing the percentage of samples accurately detected as methane leaks under prevailing environmental conditions.

20. The system of claim 19, wherein the coverage metric is used to determine a confidence level in a plurality of possible leak sources, and the probable source of the methane leak is the possible leak source with the highest confidence level.
